(19) United States
(12) Patent Application Publication
(10) Pub. No.: US 2026/0086795 A1
(43) Pub. Date: Mar. 26, 2026

(54) SYSTEM AND METHODS FOR INDEPENDENTLY DEPLOYING SERVICES WHILE PRESERVING A UNIFIED LOCAL DEVELOPMENT ENVIRONMENT

(71) Applicant: The Alfred E. Mann Foundation for Scientific Research, Valencia, CA (US)

(72) Inventor: Jay VILORIA, Orange, CA (US)

(21) Appl. No.: 19/337,697

(22) Filed: Sep. 23, 2025

Related U.S. Application Data
(60) Provisional application No. 63/698,417, filed on Sep. 24, 2024.

(51) Int. Cl. G06F 8/65

(52) U.S. Cl. CPC G06F 8/65

(57) ABSTRACT

The present disclosure generally relates to systems and methods for independently deploying services while preserving a unified local development environment. Such systems may advantageously allow developers to work locally with familiar web frameworks and configure how monolithic API endpoints will be split and deployed into separate servers. For instance, because the code base is shared locally, each service will have access to shared dependencies.

### CROSS REFERENCE TO RELATED APPLICATIONS

This application claims the benefit of U.S. Provisional Application Serial No. 63/698,417, entitled “SYSTEM AND METHODS FOR DEPLOYING SERVICES INDEPENDENTLY WHILE MAINTAINING A LOCAL UNIFIED DEVELOPMENT ENVIRONMENT” and filed on Sep. 24, 2024, which is expressly incorporated by reference herein in its entirety.

### TECHNICAL FIELD

The present disclosure generally relates to systems and methods for independently deploying services while preserving a unified local development environment.

### BACKGROUND

An Application Programming Interface (API) is a defined set of rules and protocols for building and integrating application software. APIs provide mechanisms that enable two software components to communicate with each other using a set of definitions and protocols. In other words, an API can be viewed as a contract between an information provider and an information user – establishing content required from a consumer (e.g., the call) and the content returned by the producer (e.g., the response). By way of illustration, a weather-service API may require a postal code and return a two-part response indicating a predicted high temperature and a predicted low temperature for that location.

A monolithic framework for APIs refers to an approach where substantially all functionalities of an application or service are integrated into a single unified codebase or application. The key characteristics of a monolithic framework are that the entire application or service, including its business logic, data access layer, presentation layer, and API endpoints, is built as a single unit. Accordingly, components within the application are tightly coupled, meaning that changes in one part of the codebase can affect other parts. This tight coupling makes it harder to modify or scale individual components independently. In addition, the entire application or service is deployed as a single unit, which often requires downtime or complex deployment strategies to update or scale. Furthermore, development teams typically work on the same codebase, which can lead to potential conflicts and coordination challenges, especially on large-scale projects.

A service-based framework (or microservices architecture) for APIs represents a more modular and distributed approach to building APIs. In such frameworks, the codebase is partitioned into smaller, independent services, each responsible for specific business capabilities. Each service typically exposes its own APIs to communicate with other services. Services are loosely coupled, meaning changes in one service are less likely to impact others, allowing for easier maintenance and scalability of individual components. In addition, services can be developed, deployed, and scaled independently, enabling faster deployment cycles and better resource utilization. Finally, development teams may work independently on different services, promoting agility and specialization within the organization.

In terms of scalability, service-based frameworks may be more scalable because individual services can be scaled horizontally (e.g., by adding more instances) based on demand, whereas monolithic applications typically scale vertically (e.g., by adding more resources to the entire application). Service-based frameworks also offer more flexibility in terms of technology stack and deployment strategies compared to monolithic frameworks, which are more rigid. However, while service-based architectures offer benefits in terms of scalability and flexibility, they also introduce additional complexity in coordinating distributed systems, managing communication between services, and ensuring data consistency.

A monolithic framework for APIs represents a unified, tightly integrated approach, while a service-based framework emphasizes modularity, independence, and scalability of individual components. Accordingly, choosing between a monolithic framework and a service-based framework may depend on factors such as project size, team expertise, scalability requirements, and anticipated growth. As such, each approach has its own trade-offs, and the decision should align with specific needs and constraints of a project. Thus, there remains a need for improved systems or methods that combine the benefits of a monolithic framework and service-based frameworks while mitigating the disadvantages of either framework.

### SUMMARY

The following presents a concise summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of techniques for implementing a system and method for deploying services in production while retaining monolithic behavior in a local development environment. In this way, the services may be deployed independently while preserving a unified local development environment. Such systems may advantageously allow developers to work locally with familiar web frameworks and to configure how monolithic API endpoints will be split and deployed into separate servers.

In some aspects of the present disclosure, a system for independently deploying services while preserving a unified local development environment is described. The system includes a local development environment comprising a monolithic Application Programing Interface (API) having a shared code base, and a set of API endpoints hosted on a single local server. The system also includes a deployment pipeline configured to deploy a plurality of services independently on separate servers based on separating the set of API endpoints into a plurality of non-overlapping subsets of API endpoints, wherein each of the non-overlapping subsets of API endpoints corresponds to a separably deployable service.

In some aspects, the deployment pipeline is configured to separate the set of API endpoints based on information contained in a configuration file included in the shared code base.

In some aspects, the local development environment further comprises: an application instance configured to register all the API endpoints locally, wherein the deployment pipeline is further configured to deploy the plurality of services deployed independently on the separate servers with an entry point that is a specific service application instance from the local development environment.

In some aspects, the entry point includes header information used by infrastructure-as-code (IaC) of the deployment pipeline to provide at least one deployed service among the plurality of services to a subset of external services.

In some aspects, the entry point includes header files for each entry point of a particular service, wherein the header files are configured to be parsed in the deployment pipeline for setting granular permissions at a service level during deployment.

In some aspects, the plurality of deployed services is configured to register the plurality of non-overlapping subsets of API endpoints based on the shared code base.

In some aspects, the monolithic API endpoints correspond to monolithic representational state transfer (REST) API endpoints.

In some aspects, the shared code base is configured to organize the set of API endpoints based on a deployed service.

In some aspects, the plurality of deployed services comprises at least one of shared dependencies, the set of API endpoints, and an application instance.

In some aspects, the plurality of deployed services comprises: a first deployed service having access to a first external service and not having access to a second external service, and a second deployed service having access to the second external service and not having access to the first external service.

In some aspects, the system further comprises an API gateway configured to obtain requests from a user, route the requests to appropriate services, and manage APIs.

In some aspects of the present disclosure, a method of independently deploying services while preserving a unified local development environment is described. The method includes sharing, in a local development environment, a code base locally. The local development environment includes a monolithic Application Programing Interface (API) having the shared code base and a set of API endpoints hosted on a single local server. The method also includes deploying a plurality of services independently on separate servers based on separating the set of API endpoints into a plurality of non-overlapping subsets of API endpoints. Each of the non-overlapping subsets of API endpoints corresponds to a separably deployable service.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an exemplary embodiment of a representational state transfer (REST) Application Programming Interface (API)/Web API configuration.

FIG. 2 is a diagram illustrating an exemplary embodiment of a monolithic architecture.

FIG. 3 is a diagram illustrating an exemplary embodiment of a service-based architecture.

FIG. 4 is an example diagram depicting an exemplary embodiment of a deployment pipeline of splitting a cloud service provider deployment while maintaining local development environment in accordance with aspects of this disclosure.

FIG. 5 shows a process flow for a service entry point configuration in accordance with aspects of this disclosure.

FIG. 6 is an example of a solution for deploying a cloud service provider while maintaining a local development environment using the systems described herein in accordance with aspects of this disclosure.

FIG. 7 is an example of another embodiment for deploying a cloud service provider while maintaining a local development environment using the systems described herein in accordance with aspects of this disclosure.

FIG. 8 is an example of a cloud-service and API gateway implemented for a medical device environment using the systems described herein in accordance with aspects of this disclosure.

FIG. 9 is a conceptual flowchart summarizing a method for splitting cloud service provider development while maintaining a local development environment using the systems described herein in accordance with aspects of this disclosure.

FIG. 10 illustrates a block diagram of a computing device.

Like reference numbers and designations in the various drawings indicate like elements.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of exemplary embodiments according to the present disclosure will now be presented with reference to various systems and methods. These systems and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), application-specific integrated circuits (ASICs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As noted above, the present disclosure is generally directed to systems and methods for independently deploying services while preserving a unified local development environment. With representational state transfer (REST) Application Programming Interface (API) development on a cloud service provider, developers must make an architectural choice between a monolithic API that contains all logic in a single code base and splitting the code base into separately deployed services. Splitting the code base into separate services has the production advantage of being able to apply principles of least privileges regarding security/access permissions needed for each deployed service. However, splitting the code base also has a downside of being locally more difficult to test and develop on and increases the difficulty of managing and maintaining shared dependencies as compared to a monolithic API that contains all logic in a single code base. Accordingly, a monolithic API has the opposite tradeoffs because it is easier to work with locally, but inefficient because its privilege must be the union of all its services. Accordingly, there exists a need in the art for the systems described herein, which provides a system and method for working with separately deployed services locally as if the deployed services were part of a monolithic code base.

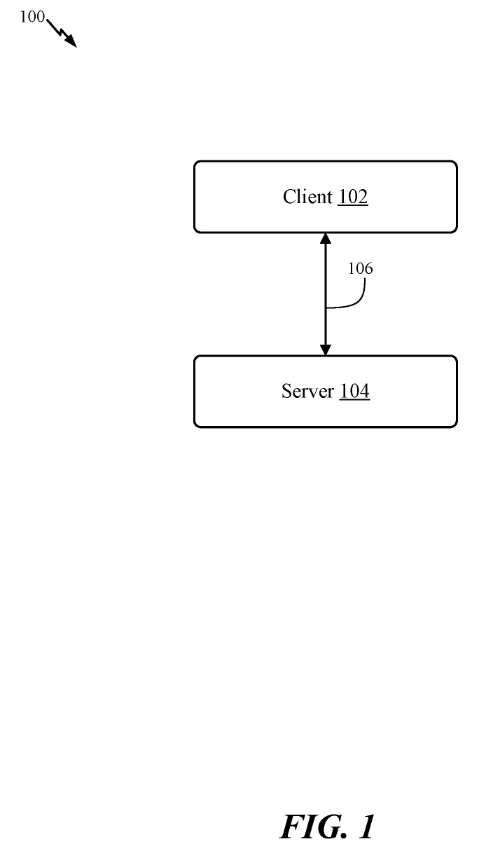

FIG. 1 is a diagram illustrating an exemplary embodiment of a REST API/Web API configuration. A REST API is a specific type of API that allows for client 102 – server 104 communication over a defined interface (e.g., JSON/XML structured objects). As described above, an API defines the rules that must be followed in order to communicate with other software systems. Developers expose or create APIs so that other applications can communicate with their applications programmatically. For example, a timesheet application exposes an API that asks for an employee’s full name and a range of dates. When the API receives this information, it may internally process the employee’s timesheet and return the number of hours worked in that data range. In simpler terms, a web API may act as a gateway between a client 102 and a server 104 with resources on the web. Some examples of an API may include medical/healthcare APIs. An exemplary medical environment may include a stimulation system having an implantable stimulator such as a pulse generator, implanted in a patient’s body, to treat the patient via electrical stimulation. Such a stimulation system further includes a clinician programmer (CP) and a patient remote (PR) each electronically coupled to (i.e., in wireless RF communication with) the implantable stimulator. The clinician programmer and the patient remote are devices that are used by a clinician and a patient respectively, to control or adjust various parameters, dosage and/or schedule of the electrical stimulation. Generally, the patient remote that is operable by the patient has fewer control parameters/features than the clinician/practitioner. The clinician programmer and the patient remote may have various graphical interfaces and/or web-based application interfaces configured to use APIs to access patient’s data, schedule or manage clinic visits, and/or to provide functionality to create or modify stimulation therapy or control/adjust other functions of the implantable stimulator. APIs used in this example may be REST APIs.

REST is a specific software architecture that imposes conditions on how an API should work. REST was initially created as a guideline to manage communication on a complex network such as the Internet. REST-based architecture supports high-performing and reliable communications at scale and may be easily implemented and modified to bring visibility and cross-platform portability to any API system.

As shown in example 100 of FIG. 1, the client 102 and the server 104 are connected via a REST API 106 (or RESTful API). The REST API is an interface that two computer systems use to exchange information securely over the internet. A majority of business applications have to communicate with other internal and third-party applications to perform various tasks. As a non-limiting example, to generate monthly pay slips, a business’s internal accounts system has to share data with the business customer’s banking system to automate invoicing and communicate with an internal timesheet application. REST APIs support this information exchange because they follow secure, reliable, and efficient software communication standards.

The client 102 corresponds to users who want to access information from the web. The client 102 may be a person or a software system that uses the API. For example, developers may write programs that access weather data from a weather system.

The server 104 may contain resources on the web. Resources are the information that different applications provide to their clients 102. Resources may be images, videos, text, numbers, or any type of data. The machine that gives the resource to the client is also called the server 104. Organizations use API to share resources and provide web services while maintaining security, control, and authentication. In addition, APIs help determine which clients get access to specific internal resources.

API developers may design APIs using several different architectures. APIs that follow the REST architectural style are called REST APIs. Web services that implement REST architecture are called RESTful web services. The term RESTful API generally refers to RESTful web APIs. However, in this present disclosure the terms REST API and RESTful API may be used interchangeably.

The REST architectural style is grounded in several principles. For example, uniform interface is pivotal for any REST webservice. This means the server 104 conveys information in a standardized format (e.g., representation in REST), enforcing four architectural constraints. Requests must identify resources using a uniform resource identifier. Clients 102 possess adequate information in the resource representation to modify or delete the resource, facilitated by the server 104 sending metadata describing the resource further. Clients 102 also receive information on how to process the representation further through self-descriptive messages containing metadata. Additionally, clients 102 are provided information on all other related resources required to complete a task, achieved through hyperlinks in the representation for dynamic resource discovery.

Further, statelessness is fundamental in REST architectures by denoting a communication method where the server fulfills each client request independently of previous requests. Clients 102 can request resources in any order, and each request is isolated from others. This implies that the server 104 can understand and fulfill requests consistently.

Also, in a layered system architecture, clients 102 may connect to authorized intermediaries between them and the server 104 and still receive responses. Servers may also forward requests to other servers, allowing RESTful web services to operate across multiple servers with various layers (e.g., security, application, and business logic) collaborating to fulfill client requests, remaining transparent to the client 102.

RESTful web services support caching, enhancing server response time by storing some responses on the client 102 or an intermediary. For instance, common header and footer images on a website can be cached after the initial response, reducing redundant server requests. APIs define responses as cacheable or noncacheable to manage caching effectively.

In the REST architectural style, servers can temporarily extend or customize client functionality by transferring software programming code to the client 102. For example, a user filling a registration form may receive immediate feedback on errors, such as an incorrect phone number.

The functionality of REST APIs may be likened to browsing the internet. When a client 102 needs a resource, it contacts the server 104 via the REST API 106. API developers provide instructions on utilizing the REST API 106 through server application API documentation. The typical steps for any REST API call are as follows. First, the client 102 dispatches a request to the server 104, adhering to the API documentation for proper formatting. Second, the server 104 authenticates the client 102 and verifies its authorization to make the request. Third, the server 104 receives and internally processes the request. Fourth, the server 104 sends a response back to the client 102, indicating the success of the request and providing any requested information.

REST APIs offer scalability, flexibility, and independence. By optimizing client-server interactions, REST enables efficient scaling. Statelessness reduces server load by eliminating the need to retain past client request information. Caching further reduces client-server interactions. RESTful web services also promote client-server separation, simplifying and decoupling server components for independent evolution. Flexibility is enhanced through layered application functions, enabling changes to specific layers without affecting others. Additionally, REST APIs are technology-independent, allowing developers to write client and server applications in various programming languages without impacting API design. This flexibility extends to changes in underlying technology on either side without disrupting communication.

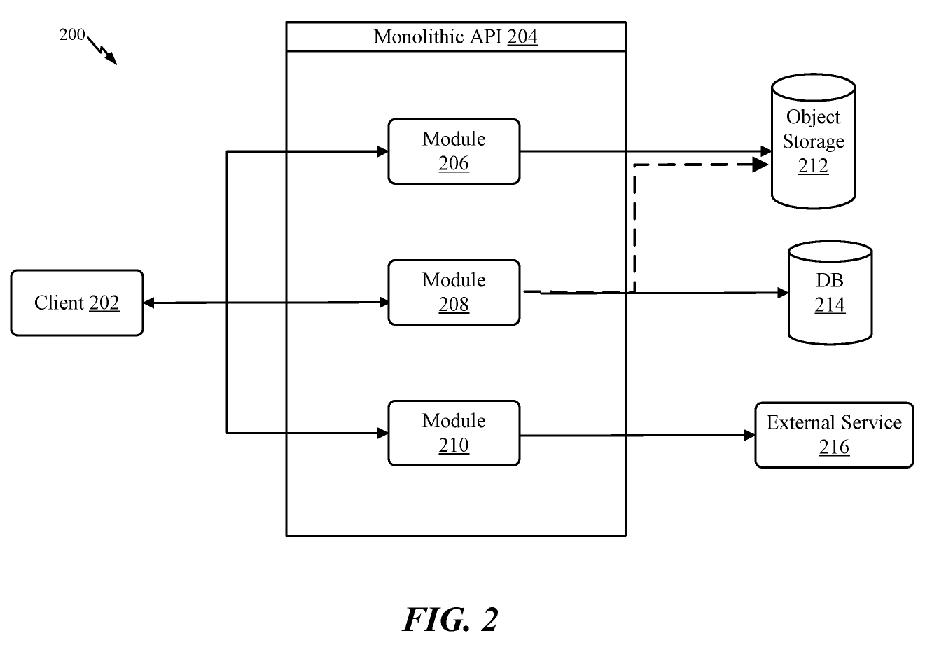

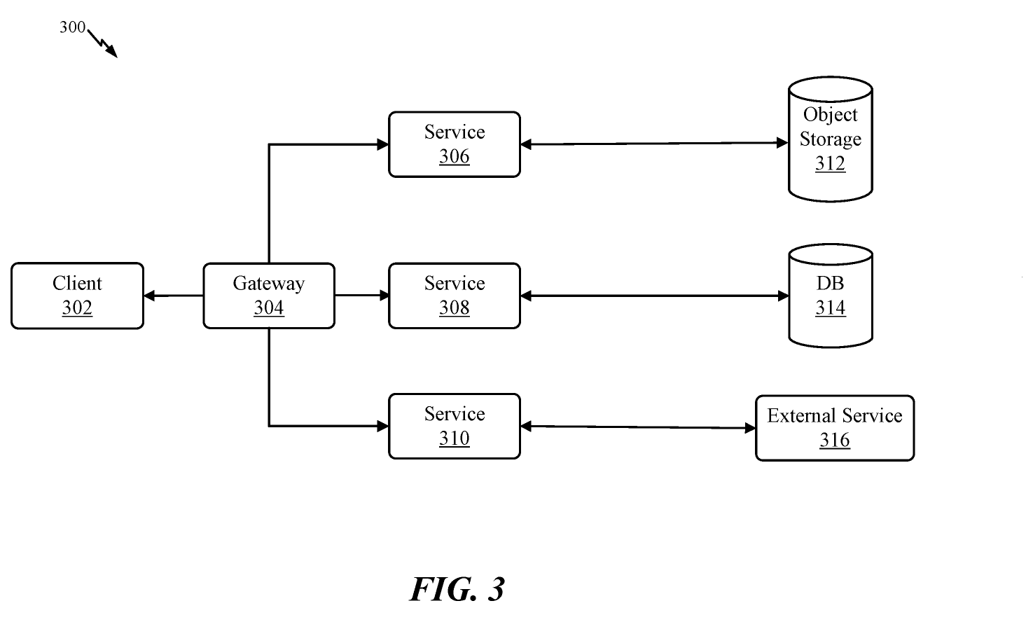

In the world of software development, how a developer structures their application can have a big impact on how it works and how easy it is to manage. Two common ways to structure software are called monolithic architectures (as described below in FIG. 2) and service-based or microservice (as described below in FIG. 3) architecture. Organizations may benefit from having either a monolithic or service-based architecture, depending on a number of different factors.

FIG. 2 is a diagram illustrating an exemplary embodiment of a monolithic architecture. Specifically, example 200 of FIG. 2 shows an example of a modular monolithic API architecture comprising module 206, module 208, and module 210. A client 202 (e.g., client 102 from FIG. 1) may interact with the monolithic API 204 containing different modules (e.g., module 206, module 208, and module 210) and each of the different modules may connect with items hosted and managed outside of the primary application’s infrastructure such as an object storage 212, external databases 214, external services 216, or the like.

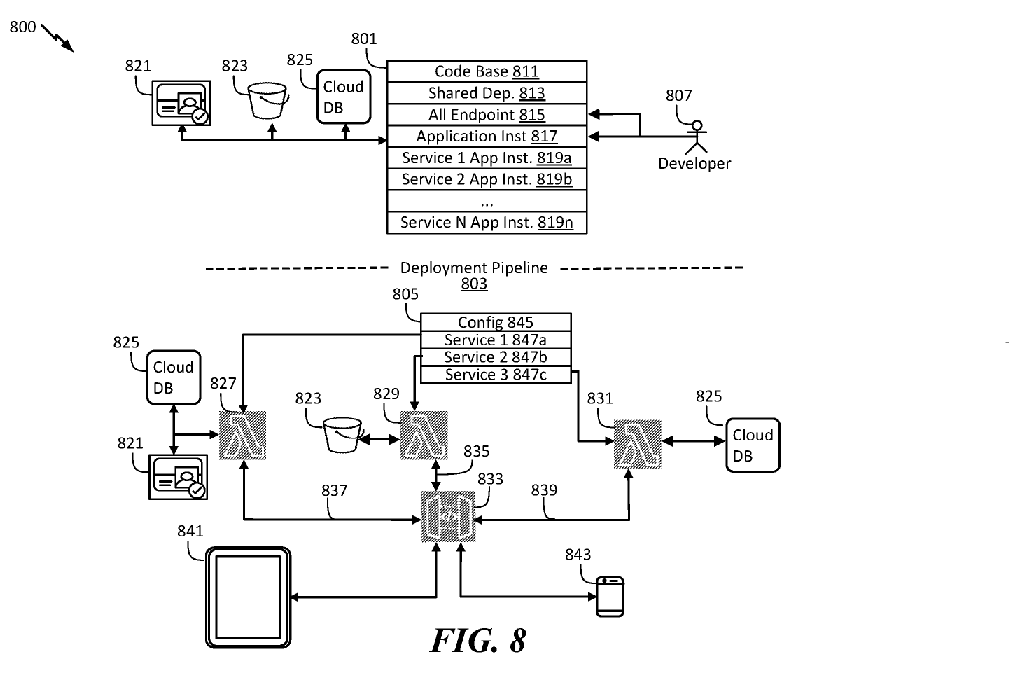

As a non-limiting example of a medical environment (e.g., implantable stimulation systems), the modules may be applications or services hosted on a Clinician Programmer (CP)/ Patient Remote (PR) (PR), and they may relate to device communication, management of a stimulation system, etc. As will be described in more detail in FIG. 8, module 206 may correspond to storing device logs and module 208 may correspond to creating a patient profile.

A disadvantage of the monolithic API 204 is that even though the intent is that module 206 should only have access to object storage 212 because the modules are all part of the same service or monolith, module 808 may conceptually access object storage 212 as indicated by a dashed line. This is due to each modular part of a monolith having access to anything the monolith has access to. In other words, the monolith has the permission of the union of the modules. In some cases, a developer may not want particular modules to access all of the external services (e.g., object storage 212, database 214, or external services 216) connected to a monolithic API 204 due to security reasons.

A monolithic API 204 architecture represents the conventional approach to software development, where a program is constructed as a cohesive entity, operating independently from other software applications. The term "monolith" suggests something massive and immovable, accurately characterizing the nature of this architectural style in software design. In a monolithic architecture, all components such as module 206, module 208, and module 210 are tightly integrated into a single, expansive computing network, sharing a common code base that interconnects all business functionalities. Any modification to such an application necessitates altering the entire stack, involving accessing the central code base and deploying an updated version of the server-side interface. Consequently, implementing changes becomes a cumbersome and time-intensive process.

Monoliths may be convenient early on in a project’s life due to its ease of code management, cognitive overhead, and deployment since everything in the monolith can be released at once. When developing using a monolithic architecture, the primary advantage is fast development speed due to the simplicity of having an application based on a single code base.

Other advantages of having a monolithic architecture are that it is considered to be a “traditional” architecture. In addition, a monolithic architecture has a simpler, code base that tends to be more organized and readable. In addition, when an application is built with a single code base, it is easier to develop. Furthermore, in a centralized code base and repository, one API can often perform the same function that numerous APIs perform with microservices. Furthermore, many tools already exist for developing and testing locally, document generation, and the like. Since a monolithic application is a single, centralized unit, end-to-end testing can be performed faster than with a distributed application. Finally, since all the code is located in one place, debugging is convenient because it is easier to follow a request and find an issue.

Monolithic applications can be quite effective until they grow too large and scaling becomes a challenge. Making a small change in a single function requires compiling and testing the entire platform, which goes against the agile approach today’s developers favor.

The main disadvantage of having a monolithic architecture is that deploying a change means re-deploying the entire monolith. For example, even a small change to a module 206 requires the redeployment of the entire monolithic API 204. Additionally, any changes in a framework or language will affect the entire application, making changes expensive and time-consuming. Accordingly, a large, monolithic application makes development more complex and slower. There is no ability to scale individual components. In addition, if there is an error in any module, then that error may affect the availability of the entire application. Finally, as mentioned above, monolithic architecture provides less granular permissions, which means that each modular part of a monolith has access to anything the monolith has access to.

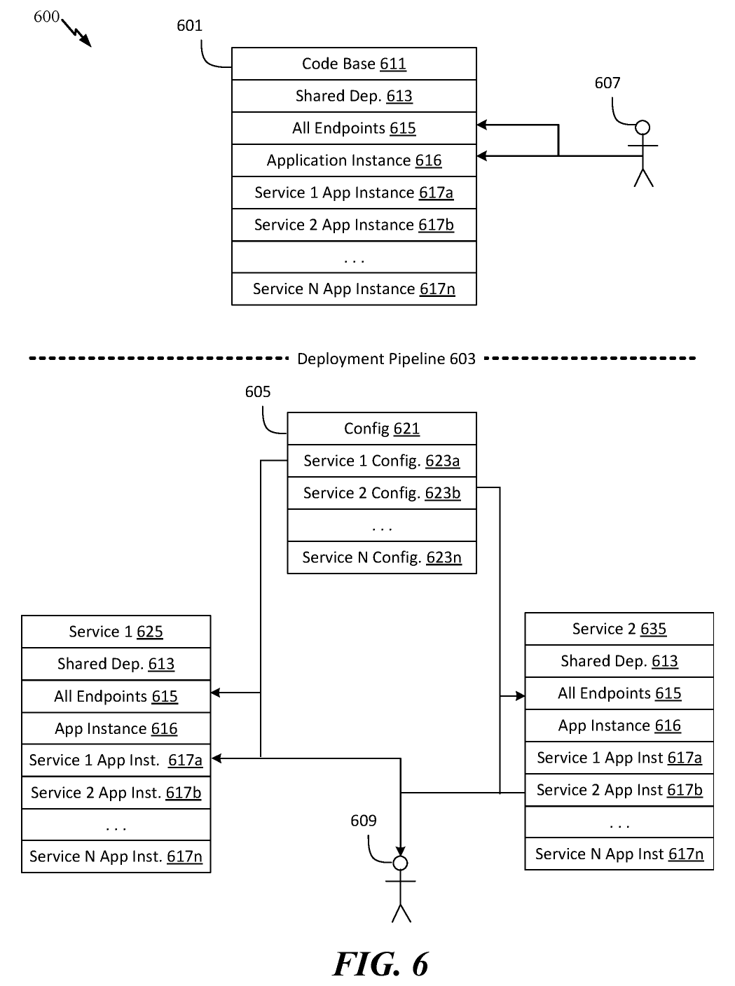

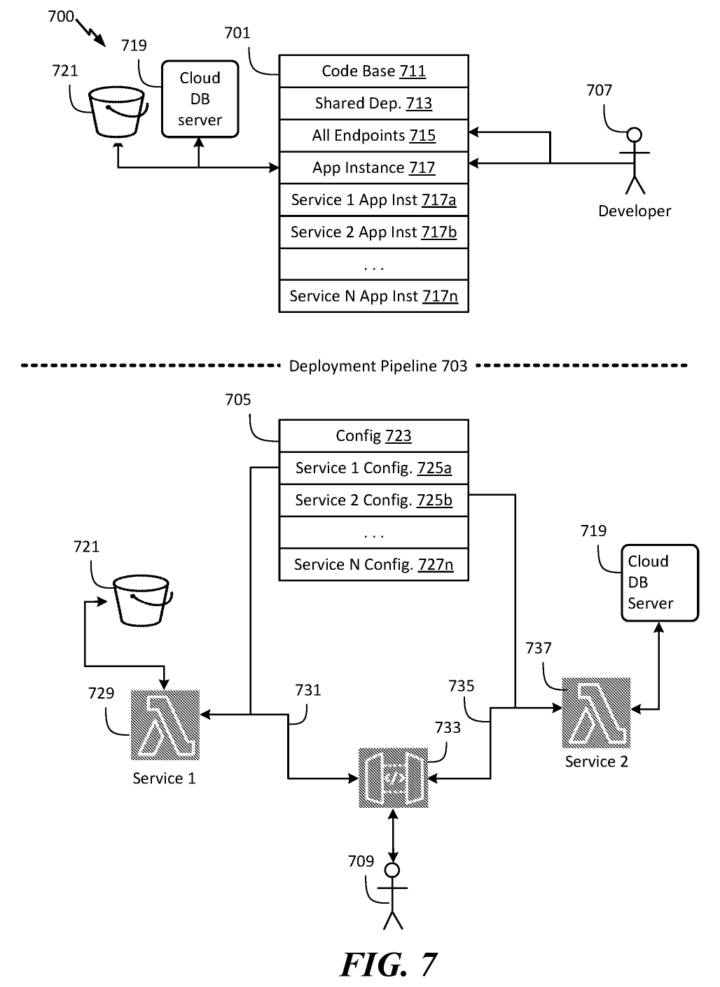

Monolithic applications may consist of a client-side user interface (UI), a database, and a server-side application. Accordingly, developers build all of these modules (e.g., module 206, module 208, module 210) on a single code base (e.g., code base 611 from FIG. 6, code base 711 from FIG. 7, or code base 811 from FIG. 8). On the other hand, in a service-based architecture, each service works to accomplish a single feature or business logic and instead of exchanging data within the same code base, services communicate with an API.

FIG. 3 is a diagram illustrating an exemplary embodiment of a service-based architecture. In contrast to example 200 of FIG. 2, where each module in the monolithic API 204 has permissions of the union of the modules, each service (e.g., service 306, service 308, service 310) only has access to its respective external service. In other words, each service may be considered its own individual monolith. Specifically, example 300 of FIG. 3 shows an example of a service-based architecture where a client 302 connects, via a gateway 304, to individual services (e.g., service 306, service 308, and service 310) that only have access to each of their respective external parts (e.g., object storage 312, database 314, external service 316).

A service-based architecture (e.g., also known as a microservice) is an architectural method that relies on a series of independently deployable services (e.g., service 306, service 308, and service 310). These services each have their own business logic and database with a specific goal. Accordingly, updating, testing, deployment and scaling occurs within each service. Microservices decouple major business, domain-specific concerns into separate, independent code bases. Microservices do not necessarily reduce complexity, but they make any complexity visible and more manageable by separating tasks into smaller processes that function independently of each other and contribute to the overall whole.

Microservices are not a cure-all solution, but they effectively address several challenges faced by expanding software and companies. With a microservices architecture, each component operates independently, allowing for individual development, updates, deployment, and scaling without disrupting other services. This setup enables more frequent software updates, leading to enhanced reliability, uptime, and performance.

A main advantage of the service based architecture includes granular permissions such that each service has access to only what it needs to have access to. In addition, service based architecture has flexible scaling. If a microservice reaches its load capacity, new instances of that service can rapidly be deployed to the accompanying cluster to help relieve pressure. In addition, since each component is effectively independent of each other, it is easier to isolate and fix bugs in individual services and provide continuous deployment. This makes it easier to update code and accelerate time-to-market for new features. Furthermore, since the services are individual units, they allow for fast and easy independent deployment of individual features, which fits cloud architecture patterns well.

The disadvantages of the service based architecture are that the code base tends to be more complex compared to a monolith architecture since there are more services in more places created by multiple teams of developers. If development sprawl is not properly managed, then this will result in slower development speed and poor operational performance. There may be difficulties when developers are working with shared logic. Finally, due to the isolated workflow of different services, it is difficult to test the services locally.

In addition to considering the advantages and disadvantages of a monolithic architecture versus a service based architecture, developers should also consider the advantages and disadvantage of developing software in a local development environment (e.g., on local machines) and on a deployed service (e.g., remote deployment on clusters). For example, if developers prefer a single simple code base, simple permission (e.g., local developer permissions), and easier documentation then a monolithic architecture should be used. However, if developers prefer granular permissions for security and isolated services for ease of deployment, then a service based architecture should be used.

A local development environment refers to an environment where software developers write, modify, and test their code on their own computers or local servers before deploying it to a production (interchangeably referred to as deployment or deployed) environment. This typically involves using development tools, Integrated Development Environments (IDEs), and local servers to simulate the production environment on a developer’s machine. An advantage of a local development is that developers can work offline and independently. Another advantage of the local development is faster iteration and debugging cycles because there is no latency related to remote servers. Finally, local development enables easier experimentation and testing of new features without affecting the live application.

A deployed environment refers to an environment where a final version of the application is deployed and accessed by end users. This environment is typically hosted on remote servers (e.g., cloud servers or dedicated hosting) and is optimized for performance, reliability, and security. An advantage of a deployed service is that it provides access to the application to end-users over the internet. Another advantage is that it easily scales to handle larger traffic and usage patterns. Finally, deployed services may include monitoring, logging, and backup to ensure reliability and availability.

Local development is limited to the developer’s own machine or a local network, while deployed services are accessible globally via the internet as they are hosted on different servers. In addition, local development is generally better suited for coding, testing, and debugging new features and changes, whereas deployed services are better suited for serving the application to end users. Local development often mimics the production environment, but may have differences (like sample data, debugging tools) that make it easier for development. Deployed services are configured for optimal performance, security, and scalability.

Considering trade-offs between local deployment and remote deployment environments (e.g., deployed services) involves careful consideration of specific project requirements, team dynamics, and organization objectives, as both options have distinct advantages and challenges. Local development offers speed, efficiency, privacy, and control. In addition, local development allows developers to work offline, experiment freely, and control their deployment setup fully. However, local development may lack scalability testing and can present collaboration and platform compatibility challenges. Conversely, deployed services provides accessibility, scalability, and often cost efficiency. However, deployed services introduce dependencies on internet connectivity, limited customization, and reliance on service providers. Ultimately, the choice may depend on project complexity, data sensitivity, regulatory requirements, and budget constraints.

Accordingly, there should be a way of incorporating the advantages of both a monolithic architecture and a service based architecture, while minimizing the disadvantages of each type of architecture. Specifically, the present disclosure allows developers to locally organize their code into a monolith with separate modules and deploy each module of the monolith separately while maintaining/preserving a unified local development environment such that the services only have access to external services that they have permissions for.

The present disclosure allows developers to work locally with familiar web frameworks. In addition, the present disclosure also allows developers to configure how monolithic REST API endpoints will be split and deployed into separate servers.

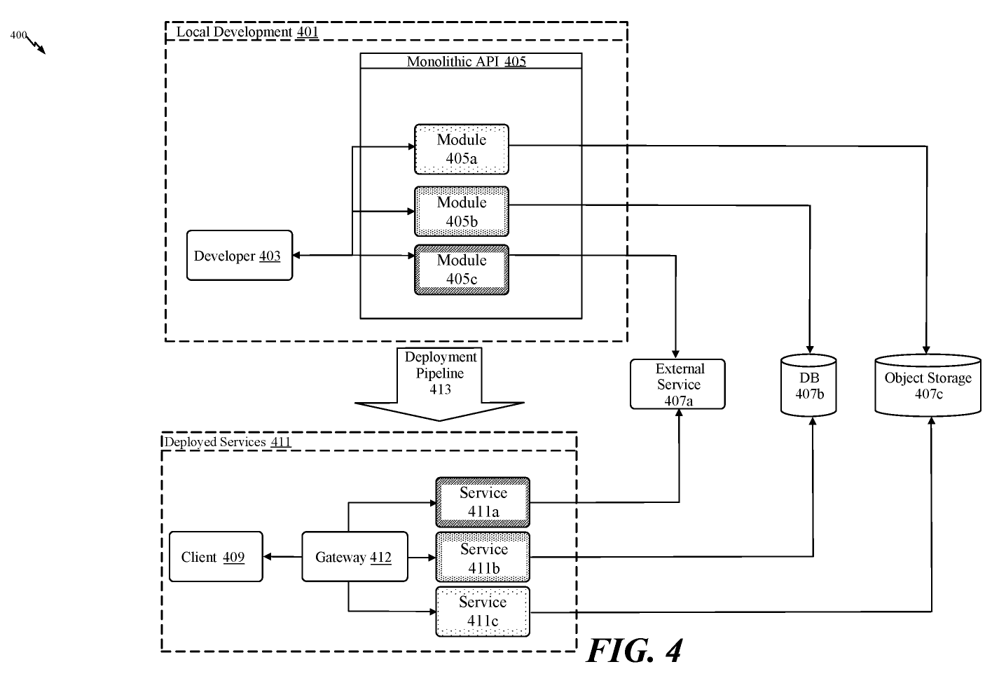

FIG. 4 is an example diagram depicting an exemplary embodiment of splitting a cloud service provider deployment while maintaining local development environment in accordance with aspects of this disclosure. As explained above, local development 401 and deployed services 411 refer to two distinct environments in software development where applications are built, tested, and run. A local development 401 environment is where developers create and refine software, while deployed services 411 are where the finished application or services are hosted and accessed by its users.

Splitting the code base into separate deployed services (e.g., service 411c, service 411b, and service 411a) also has the production advantage of being able to apply the principle of least privileges regarding security and access permissions needed for each deployed service. Separate deployed services have the trade-off that it is locally more difficult to test and develop on while increasing the difficulty of managing and maintaining shared dependencies. A monolithic single code base makes the opposite trade-off – it is easier to work with locally, but inefficient in that its privileges must be the union of all its services.

The present disclosure describes a system and method for a developer 403 to work with modules (e.g., module 405a, module 405b, module 405c) in the monolithic API 405 in a local development 401 environment while allowing the services (e.g., service 411c, service 411b, and service 411a) to be deployed separately to a client 409 via a gateway 412. For example, with REST API development on a Cloud Service Provider, there is an architectural choice between a monolithic API 405 that contains all logic in a single code base and splitting the code base into separately deployed services 411. In this way, a client 409 may work with separately deployed services (e.g., service 411c, service 411b, and service 411a) as though they were part of a monolithic code base.

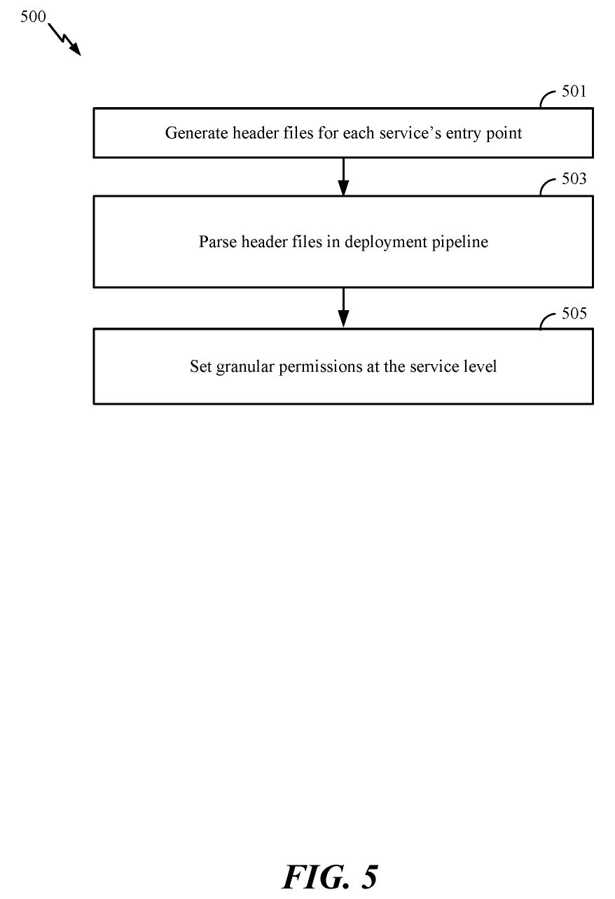

As shown in the system 400 of FIG. 4, a local development 401 environment includes a monolithic API 405 (e.g., example 200 shown in FIG. 2) that includes at least module 405a, module 405b, and module 405c, which are each connected to items hosted and managed outside of the primary application’s infrastructure (e.g., an external service 407a, a remote database 407b, and an object storage 407c), a deployment pipeline 413 (which will be described below in FIG. 5) configured to deploy a service, and a deployed services 411 environment (e.g., example 300 shown in FIG. 3) that includes a gateway 412 connecting the client 409 to service 411a, service 411b, and service 411c.

When deploying services in the deployment pipeline 413, the application instance typically has a “run” command that is part of the service’s handler/entry point, which is also used to start the service locally. In particular, the deployment pipeline 413 effectively removes the monolith and deploys the external services separately such that locally the monolith may access the items hosted and managed outside of the primary application’s infrastructure (e.g., external service 407a, database 407b, and object storage 407c), but, when the services are deployed, the deployed services only have access to their corresponding items as specified by service-level permissions.

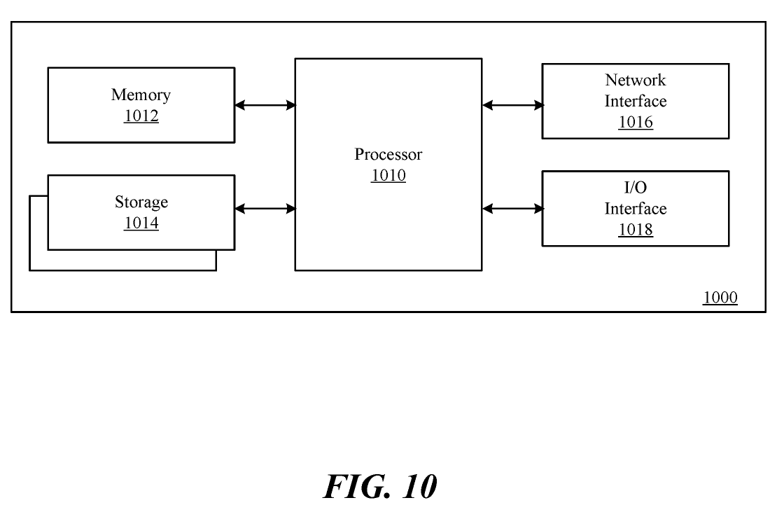

FIG. 5 shows a process flow for a service entry point configuration in accordance with aspects of this disclosure. In general, it is noted that parts of the exemplary method 500 can be implemented using the components and systems described herein, especially with request to the computing device 1000 of FIG. 10 as described above. The method 500 in FIG. 5 describes a method of setting up and defining how external clients (e.g., applications, services, or users) interact with an API by setting granular permissions at the service level. This configuration is crucial for controlling access, ensuring security, and managing traffic to the API.

At step 501, the method 500 includes, for each service that is part of the monolith, generating a header file for the service to use as an entry point such that each service contains its own header file for an entry point. Entry point files allow each service to become its own “monolith.” Specifically, the header file contains metadata that helps with deployment. As an example, referring back to system 400 of FIG. 4, the service 411c, service 411b, and service 411a may be deployed separately such that each service acts as its own monolith.

Each “deployed” service will only register a subset of endpoints in a non-overlapping fashion based on a configuration file included in a shared code base that the developer controls into its own application instance, which serves as that specific service’s handler/entry point.

At step 503 of method 500, the header files are parsed in the deployment pipeline.

At step 505 of method 500, the parsed header files are used to set granular permissions at the service level. In certain implementations such as in medical devices, granular permissions enforce least privilege access to external resources.

FIG. 6 is an example of a solution for independently deploying services while preserving a unified local development environment using the systems described herein. As compared to system 400 of FIG. 4, the code base 611 corresponds to the monolithic API 405 shown in FIG. 4 and the service configs (e.g., service 1 config 623a, service 2 config 623b, service n config 623n) corresponds to the different services (service 411c, service 411b, and service 411a shown in FIG. 4).

The system 600 of FIG. 6 also shows a system diagram and interaction between a monolithic API (e.g., code base 611) that contains all logic in a shared code base 611 and splitting the shared code base 611 into separately deployed services (e.g., service 1 625 and service 2 635). In this way, developers may work with separately deployed services locally as if they were part of a monolithic code base.

As shown in the system 600 of FIG. 6, a developer 607 may interact with the shared code base 611 as a monolith in a local development environment 601. The shared code base 611 includes shared dependencies 613, all endpoints 615, main application instance 616, and various service application instances (e.g., service 1 application instance 617a, service 2 application instance 617b,..service N application instance 617n). Specifically, in the local development environment 601, the developer 607 may work with the main application instance 616 that includes all of the endpoints 615, which correspond to the modules 405a, 405b, 405c as shown in FIG. 4, and the various service application instances (e.g., service 1 application instance 617a, service 2 application instance 617b,..service N application instance 617n).

The deployment pipeline process 603 includes a config file 621 (e.g., service 1 config 623a, service 2 config 623b, and service 3 config 623c) that is used to split the code base 611 (specifically, all endpoints 615 in the shared code base 611) into individual deployed services (e.g., service 1625 and service 2635). In some examples, the configuration file is included in the shared code base 611. At the time of deployment, the configuration file may be accessed and the API endpoints are separated. The config file 621 contains various service configs (e.g., service 1 config 623a, service 2 config 623b,…service n config 623n). In some examples, the config file 621 includes information on how to split endpoints 615 as well as what privilege/permissions the individual services need. As another example, the config file 621 may be used in the service entry point configuration method 500 shown above in FIG. 5.

As part of the deployment pipeline process 603, the config file 621 is used to organize endpoints (interchangeably referred to as API endpoints) by “deployed” service in the deployed cloud environment 605. Specifically, a plurality of services may be deployed independently on separate servers based on separating a set of API endpoints 615 into a plurality of non-overlapping subsets of API endpoints such that each of the non-overlapping subsets of API endpoints corresponds to a separably deployable service (e.g., service 1 625, service 2 635). As mentioned above, the set of API endpoints may be separated based on information contained in the config file 621 included in the shared code base 611.

Each “deployed” service will only register a subset of endpoints based on the configuration file that the developer 607 controls into its own application instance which will then serve as that specific service’s handler/entry point. The deployment pipeline process 603 will include this config file 621 file when deploying any specific service as well as Infrastructure-As-Code (IAC) that connects the config file 621 to a set of privileges and/or permissions that the service needs. Locally, the main application instance 616 that registers all endpoints 615 can still be used as if the endpoints were part of a monolithic API.

In addition, since the shared code base 611 is shared locally, each service will have access to shared dependencies 613 in the deployed cloud environment 605. In some examples, some shared dependencies 613 may be duplicated across separately deployed services, which adds to total bundle size. However, this may be an acceptable trade-off for the benefits because the extra size of duplicated dependencies may be mitigated by packaging dependencies into separate external libraries that can also be part of deployment configuration for each service.

When the services (e.g., service 1 625 and service 635) are deployed, the entry point for an API consumer 609 may be a specific service application instance (e.g., service 1 application instance 617a and service 2 application instance 617b) that only contains a subset of the endpoints 615. Thus, from the API consumer 609 side, it appears as a service based architecture (e.g., example 300 from FIG. 3), but from the developer 607 side, it appears as a monolithic architecture (e.g., example 200 from FIG. 2).

FIG. 7 is an example of another embodiment for deploying a cloud service provider while maintaining a local development environment using the systems described herein. As compared to the system 600 of FIG. 6, the system 700 shows an implementation of the deployment with example cloud services.

Similar to the system 600 of FIG. 6, during the local development environment 701, the developer 707 will work with the main application instance 717 that includes all the endpoints 715. As shown in the system 700, the main application instance 717 connects to both a S3 bucket 721 and a cloud database server 719. In this way, locally, the developer 707 will have permissions that represent the union of all service privileges. As mentioned above, since the code base 711 is shared locally, each service will have access to shared dependencies 713. However, for various reasons, the developer may not want all of the services to have access to both the S3 bucket 721 and the cloud database server 719.

Similar to the deployment pipeline and deployed cloud environment shown in FIG. 6, the config 723 (e.g., configuration file) includes information such as how to split endpoints 715, what function should be used as serverless handler (e.g., an AWS Lambda handler), and what privileges/permissions each service needs. For example, when the services (e.g., service 1 729 and service 2 737) are deployed in the deployed cloud environment 705 using the deployment pipeline 703, the entry point for the API consumer 609 via an API gateway 733 may be a specific service application instance (e.g., service 1 application instance 717a and service 2 application instance 717b) that only contains a subset of the endpoints 715 – rather than all of the endpoints 715. In this way, service 1 729 will only register a first subset of endpoints 731 based on the config 723 and service 2 737 will only register a second set of endpoints 735 based on the config 723. Accordingly, service 1 729 may only have access to the S3 bucket 721 and may not have access to the cloud database server 719 and service 2737 may only have access to the cloud database server 719 and may not have access to the S3 bucket 721.

The API consumer 709 connects to an API gateway 733 that has access to endpoints of service 1 731 and endpoints to service 2 735. An API endpoint is an end of an API connection where an API call is received. In other words, API endpoints are the specific digital location where requests for information are sent by one program to retrieve the digital resources that exist there. Endpoints specify where APIs can access resources and help guarantee the proper functioning of the incorporated software. Software programs may have multiple API endpoints.

FIG. 8 is an example of a cloud-service and API gateway implemented in a medical device environment using the systems described herein.

An exemplary medical device environment may include a stimulation system (not shown) having an implantable stimulator such as a pulse generator, implanted in a patient’s body, to treat certain medical conditions in the patient via electrical stimulation. The stimulation system may further include a clinician programmer (CP) and a patient remote (PR) each electronically coupled to (i.e., in wireless RF communication with) the implantable stimulator. The clinician programmer and the patient remote are devices that are used by a clinician and a patient respectively, to control or adjust various parameters, dosage and/or schedule of the electrical stimulation. Each of these devices, CP or PR, may be a software application installed on an electronic device (e.g., a smartphone, a wearable device, or a dedicated computing device).

Similar to the systems 600 and 700 of FIGS. 6-7, in the local development environment 801, the developer 807 may work with the main application instance 817 that includes all the endpoints 815. The main application instance 817 connects to a cloud database server 825, CP/PR device logs 823, and a user authentication and user management service 821.

In addition, similar to the deployment pipeline and deployed cloud environments shown in FIGS. 6-7, the config 805 includes information on how to split endpoints 715, and what privileges/permissions each service needs. As shown in the system 800 of FIG. 8, service 1 847a corresponds to creating a patient service, service 2 847b corresponds to uploading log service, and service 3847c corresponds to registering a PR service. Each deployed service (e.g., creating a patient service 827, upload log service 829, and register PR service 831) is independent and only has access to the services (e.g., cloud database server 825, CP/PR device logs 823, and user authentication and user management service 821) as defined by the config 805 used during the deployment pipeline 803.

In some examples, the CP 841 and the PR 843 connect to the APIs via a REST API gateway 833. Specifically, the REST API gateway 833 connects the CP 841 and the PR 843 to endpoints for creating patient service 837, endpoints for uploading log service 835, and endpoints for registering PR service 839 and each individual service may only have access to the services they need as defined by the config 845. For example, the create patient service 827 only has access to the cloud database server 825 and the user authentication and user management service 821 and does not have access to the CP/PR device logs 823; the upload log service 829 only has access to the CP/PR device logs 823 and does not have access to the cloud database server 825 or user authentication and user management service 821; and the register PR service 831 only has access to the cloud database server 825 and does not have access to the user authentication and user management service 821 or the CP/PR device logs 823.

Although FIG. 8 shows an example of the implementation in a medical device setting, the implementation of the medical device is shown as an illustrative example and the present disclosure is not limited to an implementation of a medical device.

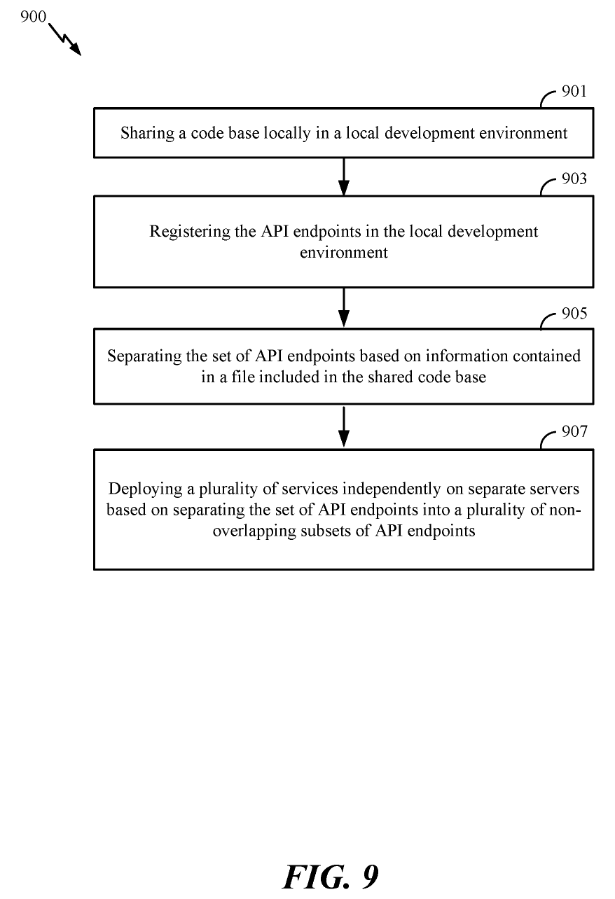

FIG. 9 is a conceptual flowchart summarizing a method for splitting cloud service provider development while maintaining a local development environment using the systems described herein. According to various different aspects, one or more of the illustrated blocks of method 900 may be omitted, transposed, and/or contemporaneously performed. The method allows a system (e.g., the system 400 shown in FIG. 4, the system 600 shown in FIG. 6, the system 700 shown in FIG. 7, the system 800 shown in FIG. 8.) to deploy services locally as if they were part of a monolithic code base.

At block 901, the method 900 may include maintaining, in a local development environment, a shared code base. The local development environment comprises a monolithic Application Programing Interface (API) having the shared code base and a set of API endpoints hosted on a single local server.

In some examples, the set of API endpoints may correspond to monolithic representational state transfer (REST) API endpoints.

In some examples, the shared code base may be configured to organize the set of API endpoints based on a deployed service.

At block 903, the method 900 may include registering all API endpoints locally. The plurality of services is deployed independently on the separate servers with an entry point that is a specific service application instance from the local development environment.

In some examples, the entry point may include header information used by infrastructure-as-code (IaC) to map endpoint subsets to corresponding services and provide the plurality of services with the plurality of non-overlapping subsets.

At block 905, the method 900 may include separating the set of API endpoints based on information contained in a file included in the shared code base.

At block 907, the method 900 may include deploying a plurality of services independently on separate servers based on separating the set of API endpoints into a plurality of non-overlapping subsets of API endpoints. Each of the non-overlapping subsets of API endpoints may correspond to a separably deployable service.

In some examples, the plurality of deployed services may be configured to register the plurality of non-overlapping subsets of API endpoints based on the shared code base.

In some examples, the deployed plurality of services comprises: a first deployed service having access to a first external service and not having access to a second external service, and a second deployed service having access to the second external service and not having access to the first external service.

It is understood that the methods illustrated by FIGS. 5 and 9 are exemplary in nature and that the steps described herein may be combined to generate alternative embodiments.

FIG. 10 is a block diagram of a computing device 1000. The computing device 1000 may include software and/or hardware for providing functionality and features described herein. The computing device 1000 may therefore include one or more of: logic arrays, memories, analog circuits, digital circuits, software, firmware and processors. The hardware and firmware components of the computing device 1000 may include various specialized units, circuits, software and interfaces for providing the functionality and features described herein. For example, a system of two physical network objects may provide continual automated discovering of the topology information of macro-clusters and relationship between those macro-clusters.

The computing device 1000 has a processor 1010 coupled to a memory 1012, storage 1014, a network interface 1016 and an I/O interface 1018. The processor 1010 may be or include one or more microprocessors, field programmable gate arrays (FPGAs), application specific integrated circuits (ASICs), programmable logic devices (PLDs) and programmable logic arrays (PLAs).

The memory 1012 may be or include RAM, ROM, DRAM, SRAM and MRAM, and may include firmware, such as static data or fixed instructions, BIOS, system functions, configuration data, and other routines used during the operation of the computing device 1000 and processor 1010. The memory 1012 also provides a storage area for data and instructions associated with applications and data handled by the processor 1010. As used herein the term “memory” corresponds to the memory 1012 and explicitly excludes transitory media such as signals or waveforms.

The storage 1014 provides non-volatile, bulk or long-term storage of data or instructions in the computing device 1000. It may be internal or external storage. The storage 1014 may take the form of a magnetic or solid-state disk, tape, CD, DVD, or other reasonably high capacity addressable or serial storage medium. Multiple storage devices may be provided or available to the computing device 1000. Some of these storage devices may be external to the computing device 1000, such as network storage or cloud-based storage. As used herein, the terms “storage” and “storage medium” correspond to the storage 1014 and explicitly exclude transitory media such as signals or waveforms. In some cases, such as those involving solid-state memory devices, the memory 1012 and storage 1014 may be a single device.

The network interface 1016 includes an interface to a network such as a network that can be used to communicate calls, signals, streams, arrays, flagged samples and feedback described herein. The network interface 1016 may be wired or wireless.

The I/O interface 1018 interfaces the processor 1010 to peripherals (not shown) such as displays, video and still cameras, microphones, keyboards and USB devices.

In some cases, storage 1014 is a non-volatile machine-readable storage medium that includes all types of computer readable media, including magnetic storage media, optical storage media, and solid-state storage media. It should be understood that the software can be installed in and sold with a client computer. Alternatively, the software can be obtained and loaded into the client computer, including obtaining the software via a disc medium or from any manner of network or distribution system, including from a server owned by the software creator or from a server not owned but used by the software creator. The software can be stored on a server for distribution over the Internet.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular compound, composition, article, apparatus, methodology, protocol, and/or reagent, etc., described herein, unless expressly stated as such. In addition, those of ordinary skill in the art will recognize that certain changes, modifications, permutations, alterations, additions, subtractions and sub-combinations thereof can be made in accordance with the teachings herein without departing from the spirit of the present specification. It is therefore intended that the following appended claims and claims hereafter introduced are interpreted to include all such changes, modifications, permutations, alterations, additions, subtractions and sub- combinations as are within their true spirit and scope.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (and equivalent open-ended transitional phrases thereof like including, containing and having) encompasses all the expressly recited elements, limitations, steps and/or features alone or in combination with unrecited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amended for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (and equivalent open-ended transitional phrases thereof) includes within its meaning, as a limiting case, claimed subject matter specified by the closed-ended transitional phrases “consisting of” or “consisting essentially of.” As such embodiments described herein or so claimed with the phrase “comprising” are expressly or inherently unambiguously described, enabled and supported herein for the phrases “consisting essentially of” and “consisting of.”

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Lastly, the terminology used herein is for the purpose of describing particular embodiments only, and is not intended to limit the scope of the present invention, which is defined solely by the claims. Accordingly, the present invention is not limited to that precisely as shown and described.

What is claimed is:

1. A system for independently deploying services while preserving a unified local development environment, comprising:
a local development environment comprising a monolithic Application Programing Interface (API) having a shared code base, and a set of API endpoints hosted on a single local server; and
a deployment pipeline configured to deploy a plurality of services independently on separate servers based on separating the set of API endpoints into a plurality of non-overlapping subsets of API endpoints, wherein each of the non-overlapping subsets of API endpoints corresponds to a separably deployable service.

2. The system of claim 1, wherein the deployment pipeline is configured to separate the set of API endpoints based on information contained in a configuration file included in the shared code base.

3. The system of claim 1, wherein the local development environment further comprises an application instance configured to register all API endpoints locally,
wherein the deployment pipeline is further configured to deploy the plurality of services independently on the separate servers with an entry point that is a specific service application instance from the local development environment.

4. The system of claim 3, wherein the entry point comprises header information used by infrastructure-as-code (IaC) of the deployment pipeline to provide at least one deployed service among the plurality of services to a subset of external services.

5. The system of claim 3, wherein the entry point comprises header files for each entry point of a particular service, wherein the header files are configured to be parsed in the deployment pipeline for setting granular permissions at a service level during deployment.

6. The system of claim 1, wherein the plurality of deployed services is configured to register the plurality of non-overlapping subsets of API endpoints based on the shared code base.

7. The system of claim 1, wherein the monolithic API endpoints correspond to monolithic representational state transfer (REST) API endpoints.

8. The system of claim 1, wherein the shared code base is configured to organize the set of API endpoints based on a deployed service.

9. The system of claim 1, wherein the plurality of deployed services comprises at least one of shared dependencies, the set of API endpoints, and an application instance.

10. The system of claim 1, wherein the plurality of deployed services comprises:
a first deployed service having access to a first external service and not having access to a second external service, and
a second deployed service having access to the second external service and not having access to the first external service.

11. The system of claim 1, wherein the plurality of services are deployed in a cloud-based server.

12. A method for independently deploying services while preserving a unified local development environment, comprising:
sharing, in a local development environment, a code base locally, wherein the local development environment comprises a monolithic Application Programing Interface (API) having the shared code base and a set of API endpoints hosted on a single local server; and
deploying a plurality of services independently on separate servers based on separating the set of API endpoints into a plurality of non-overlapping subsets of API endpoints, wherein each of the non-overlapping subsets of API endpoints corresponds to a separably deployable service.

13. The method of claim 12, further comprising:
separating the set of API endpoints based on information contained in a file included in the shared code base.

14. The method of claim 12, further comprising:
registering all API endpoints locally, wherein the plurality of services is deployed independently on the separate servers with an entry point that is a specific service application instance from the local development environment.

15. The method of claim 14, wherein the entry point comprises header information used by infrastructure-as-code (IaC) to provide the plurality of services to the plurality of non-overlapping subsets.

16. The method of claim 12, wherein the plurality of deployed services is configured to register the plurality of non-overlapping subsets of API endpoints based on the shared code base.

17. The method of claim 12, wherein the set of API endpoints corresponds to monolithic representational state transfer (REST) API endpoints.

18. The method of claim 12, wherein the shared code base is configured to organize the set of API endpoints based on a deployed service.

19. The method of claim 12, wherein the deployed plurality of services comprises:
a first deployed service having access to a first external service and not having access to a second external service, and
a second deployed service having access to the second external service and not having access to the first external service.

20. A system for independently deploying services while preserving a unified local development environment, comprising:
a local development environment including a shared code base that implements a monolithic Application Programming Interface (API), the monolithic API exposing a plurality of API endpoints that are registered in a single local application instance executing on a single local server;
a configuration file stored in the shared code base and defining, for each of a plurality of services: (a) a non-overlapping subset of the API endpoints to be exposed by that service, and (b) deployment metadata including an entry-point identifier for a service application instance and access-permission requirements for external resources; and
a deployment pipeline that is configured, based on the configuration file, to:
(a) build, for each service, the service application instance that registers only the corresponding non-overlapping subset of the API endpoints from the shared code base, and
(b) deploy each service application instance to a respective server as an independently deployable service with least privilege access to external resources in accordance with the access-permission requirements,
wherein the local development environment maintains monolithic behavior by registering all of the plurality of API endpoints in the single local application instance while the deployment pipeline separately deploys the services by the non-overlapping subsets.
